(19) United States
(12) Patent Application Publication
(10) Pub. No.: US 2007/0151630 A1
(43) Pub. Date: Jul. 5, 2007

(54) Method for making soft magnetic material having ultra-fine grain structure

(75) Inventors: Luana Emiliana Iorio, Clifton Park, NY (US); Pazhayannur Ramanathan Subramanian, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/321,986

(22) Filed: Dec. 29, 2005

(51) Int. Cl. H01F 1/12; H01F 41/02

(52) U.S. Cl. 148/120; 148/300; 148/311

(57) ABSTRACT

A method of making a soft magnetic material with ultra-fine grain structure is provided. The method includes the steps of: providing a soft magnetic starting material; and deforming the soft magnetic starting material within a dynamic recrystallization processing zone to form a billet having a grain size less than about 200 nm. An article comprising a magnetic material is provided, wherein the article is formed by: providing a soft magnetic starting material; and deforming the soft magnetic starting material within a dynamic recrystallization processing zone to form a billet having a grain size less than about 200 nm.

### BACKGROUND OF THE INVENTION

The invention is related to a method of making a soft magnetic material. More particularly, the invention is related to a method of making a soft magnetic material having ultra-fine grain structure.

Magnetic materials play a key role in a number of applications, especially in many electric and electromagnetic devices. There is a continually growing need for higher performance electric machines in various applications such as power generation. Compact machine designs may be realized through an increase in the rotational speed of the machine. In order to operate at very high speeds, these, machines need rotors with higher yield strength materials along with lower magnetic core losses, as well as the ability to operate at maximum flux densities. Generally, achieving high strength, high toughness, and superior magnetic performance concurrently is difficult in conventional materials, because high strength typically is obtained at the expense of ductility and magnetic properties such as magnetic saturation and core loss. Therefore, there is a need for a magnetic material with superior magnetic properties and higher mechanical strength when compared with currently available materials. There is a further need for an efficient method for producing these materials.

### BRIEF DESCRIPTION OF THE INVENTION

The present invention meets these and other needs by providing a soft magnetic material with ultra-fine grain structure and having a high yield strength, good ductility, and improved magnetic properties.

One embodiment of the invention described herein is a method. The method includes the steps of providing a soft magnetic starting material; and deforming the soft magnetic starting material within a dynamic recrystallization processing zone to form a billet having a grain size less than about 200 nm.

Another embodiment of the invention is to provide an article of a soft magnetic material with ultra-fine grain structure. The article is made by a method including the steps of providing a soft magnetic starting material; and deforming the soft magnetic starting material within a dynamic recrystallization processing zone to form a billet having a grain size less than about 200 nm.

### DESCRIPTION OF THE DRAWINGS

These and other features, aspects, and advantages of the present invention will become better understood when the following detailed description is read with reference to the accompanying drawing in which like characters represent like parts throughout the drawing, wherein:

FIG. 1 is a plot of yield strength verses grain size of a magnetic material; and

FIG. 2 is a flow chart of the method according to one embodiment of the invention.

### DETAILED DESCRIPTION OF THE INVENTION

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

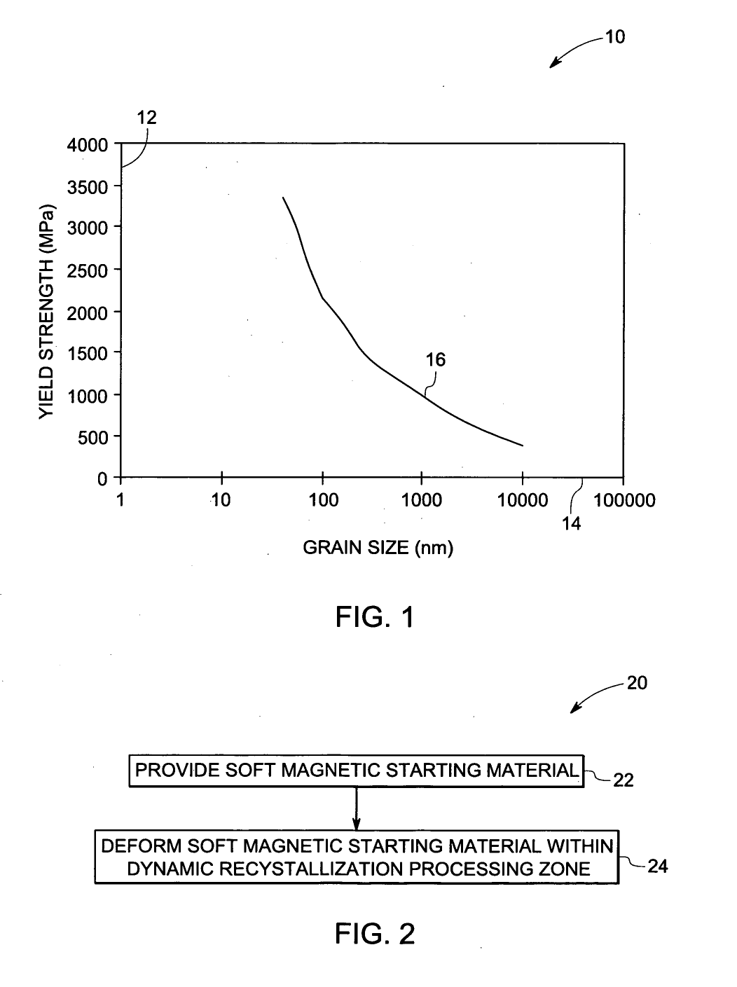

For many electrical and electromagnetic devices, soft magnetic materials with high permeability, high saturation magnetization, low core loss, high mechanical strength, and ductility are preferred. An increase in yield strength with decreasing grain size (Hall-Petch effect) may be utilized to make high strength magnetic materials. Plot 10 in FIG. 1 is a plot of yield strength (plotted along left Y axis-12) versus grain size (plotted along X axis-14). Curve 16 indicates that yield strength increases with decrease in grain size. However, in magnetic materials, the decrease in grain size is often detrimental to the magnetic properties, specifically core loss and coercivity. While it is known that typically coercivity increases with decreasing grain size in material with micron-sized grains, Herzer (G. Herzer, “Grain size dependence of coercivity and permeability in nanocrystalline ferromagnets,” IEEE Trans. Magn., vol. 26, pp. 1397-1402, 1990.), illustrated that below a critical grain size, the relationship between coercivity, H_{c}, and grain size, D, changes such that H_{c} is proportional to D^{1/6} for materials with nanocrystallites in an amorphous matrix.

Achieving magnetic materials with fine grain size, good yield strength and ductility as well as low coercivity has proven to be a very challenging task. Many methods such as rapid solidification, controlled thermal processing after conventional deformation processing, and compaction of nanocrystalline powders have been attempted to prepare ultra-fine grained magnetic materials. These methods have not been successful in producing a bulk material with minimum dimensions, such as thickness of more than about 100 micrometers, having high strength and ductility as well as high saturation magnetization and low core losses. Despite such efforts, there is no simple method to produce, on an industrial scale, bulk magnetic materials having engineered fine grain sizes minimum dimension greater than about 100 micrometers. Especially, there is a need for a method to fabricate material having a structure that falls within the preferred grain size window to provide the material with the right balance of yield strength, ductility, magnetic saturation and coercivity in a single material.

Disclosed herein is a versatile method for making magnetic materials with controlled ultra-fine grain structure, substantially high yield strength, and superior magnetic properties. In accordance with aspects of the present invention, it has been determined that it is possible to utilize the grain size effects in the sub-100 nanometer grain size regime to enhance strength (Hall-Petch Relationship) and simultaneously reduce coercivity to obtain high strength, high ductility, high saturation magnetization, and low coercivity magnetic materials. The details of the process are described in the subsequent embodiments.

For the purposes of understanding the invention, an ultra-fine grain structure is understood to be a grain structure in which the median grain size is less than about 500 nanometers. In one embodiment, the median grain size is less than about 200 nanometers and, in another embodiment, the median grain size is less than about 60 nanometers. In yet another embodiment, the median grain size is in a range from about 10 nanometers to about 60 nanometers.

A processing route is disclosed for magnetic materials through the creation of a nanocrystalline microstructure obtained through severe plastic deformation. The method involves the steps of: providing a soft magnetic starting material; and deforming the soft magnetic starting material within a dynamic recrystallization processing zone to form a billet having a grain size less than about 200 nm.

In a particular embodiment, at least about 50 weight percent of the soft magnetic starting material includes a magnetic alloy including iron (Fe), cobalt (Co), nickel (Ni), or combinations thereof. In one embodiment, the starting magnetic material comprises iron with some additives. In one embodiment, the soft magnetic starting material comprises iron and cobalt. In one embodiment, cobalt is in the range from about 15 atomic percent to about 55 atomic percent. In another embodiment, the soft magnetic starting material comprises cobalt in the range from about 30 atomic percent to about 40 atomic percent. In another embodiment, the soft magnetic starting material comprises cobalt in the range from about 45 atomic percent to about 52 atomic percent. The Fe—Co alloys desirably exhibit high saturation magnetization Bₛ, (greater than 2 Tesla) and high Curie temperatures T_{c} (T_{c}≈900° C.). The selection of a particular Co concentration in the alloy is based on a balance of factors including factors such as, for example, cost, strength, and magnetic properties, the resolution of which will depend upon the particular application desired.

In another embodiment, the soft magnetic starting material further comprises an (meaning at least one) additive selected from the group consisting of nickel (Ni), vanadium (V), chromium (Cr), molybdenum (Mo), manganese (Mn), silicon (Si), tungsten (W), tantalum (Ta), aluminum (Al), carbon (C), niobium (Nb), titanium (Ti), boron (B), and combinations thereof. These additives may be included, for instance, to improve the corrosion resistance, to enhance the resistivity, to enhance the strength, to enhance the ductility or workability of the alloy or to adjust the magnetic properties. Specific combinations of additives are chosen based on the particular requirements of specific applications. In a particular embodiment, the total amount of additive is up to about 6 atomic percent.

In yet another embodiment, the soft magnetic starting material comprises Fe, Co, and V. In some embodiments, Co is present in an amount up to about 49 atomic percent and V is present in an amount of up to about 2 atomic percent. The vanadium addition increases the resistivity and workability of the soft magnetic starting material.

FIG. 2 is a flow chart of the process of one embodiment of the invention. Method 20 includes step of providing a soft magnetic starting material in step 22; and deforming the soft magnetic starting material within a dynamic recrystallization processing zone to form a billet having a grain size less than about 200 nm in step 24. In some embodiments, the soft magnetic starting material is provided in the form of a billet. The process starts with a bulk alloy feedstock in the form of a cylindrical, square, or rectangular billet. This billet can be fabricated using one or more conventional processes such as casting or powder metallurgy, followed if necessary by thermo-mechanical processes, such as extrusion, rolling or forging. This starting magnetic material is then used as the feedstock for severe plastic deformation in step 26. Various processes may be used to deform the soft magnetic starting material. Non-limiting examples of suitable processes are equal channel angular extrusion (ECAE), twist extrusion, torsion extrusion, multi-axis forging, continuous shear deformation, and uniaxial forging.

Typically, these deformation processes involve hot extrusion of the alloy billet through a die. When the process used is equal channel angular extrusion, the die angle is 90°. When the process used is twist extrusion, the die twist angle is in a range of from about 30° to about 60°. The process may include a single pass or multiple passes through the die, and may or may not include part rotation by a specific angle between each pass. During each pass, the feedstock is subjected to extreme shear deformation, resulting in the generation of an extremely fine deformation substructure and/or significant grain refinement. Subsequent thermo-mechanical processing such as extrusion, rolling or forging; heat treatments, and aging treatments are then applied to the material, as necessary, to further refine the substructure and/or grains in the material and place the material in a condition for use in high strength structural components over a range of temperatures in electric machine applications. By controlling the extent of the extreme deformation and or/subsequent thermal treatment, nanoscale to sub-micron scale refined structures can be produced in the alloys. The final product is a fully-consolidated, dense structural component with superior mechanical and magnetic properties.

Typically, hot-forging involves the compression of a billet or bar between flat platens that may be heated to some intermediate temperatures. The forging may be conducted in a single step or in a number of stages, wherein the billet is typically reheated between the stages. Multi-axis forging is a variation of the forging process wherein the billet is open-die forged in a number of passes. Between each pass, the billet is reoriented to a different axis and each subsequent pass is conducted with a change of axis of the applied load. The process may be configured to utilize dynamic recrystallization to achieve grain refinement during open-die forging under controlled temperature and deformation-rate conditions. The above process provides the advantage of the retention of material cross-sectional area as contrasted with more conventional thermo-mechanical processing such as rolling.

The soft magnetic starting material is deformed within a dynamic recrystallization processing zone, generally defined by particular ranges of temperature, strain, and strain rate. Dynamic recrystallization is a process wherein during deformation under controlled conditions, small dislocation-free regions or sub-grains are formed by dislocation rearrangement within grains and which eventually form recrystallized grains with high-angle grain boundaries. In contrast to conventional thermo-mechanical processes, which may require subsequent heat treatment to allow highly deformed microstructures to recrystallize into new grains, in the process of the invention, the recrystallized grains are formed during the deformation process. This facilitates a good control over the microstructure, including the texture and grain size of the deformed material, by controlling the temperature, strain, and strain rate.

During deformation processing, occurrence of dynamic recrystallization depends on processing the material within appropriate ranges of applied strain, temperature, and strain rate. Dynamic recrystallization may be utilized to obtain a very fine grain microstructure of the recrystallized grains. By optimizing the applied strain, temperature, and the strain rate, it is possible to obtain ultra-fine grained microstructure in the deformed material. In one embodiment, deformation is carried out at a temperature in a range from about 600° C. to about 1000° C.

In one embodiment, deformation produces a strain in the range from about 1 to about 6. In some other embodiments, the deformation produces a strain in the range of about 2 to about 4. In one embodiment, deformation is carried out at a strain rate in the range from about 0.001/second to about 0.0001/second. In another embodiment, deforming includes deforming at a strain rate in the range from about 0.005/second to about 0.0005/second.

A grain size range exists wherein yield strength is increasing with reduced grain size and coercivity is reducing with reduced grain size. Accordingly in one embodiment, the billet of the deformed material has median grain size less than about 100 nanometers. In another embodiment, the billet has a median grain size in the range of about 10 nanometers to about 60 nanometers.

In another aspect, the invention provides an article. The article includes a magnetic material, wherein the article is formed by: providing a soft magnetic starting material; and deforming the soft magnetic starting material within a dynamic recrystallization processing zone to form a billet having a grain size less than about 200 nm. The composition of the material, the deformation process, and the grain structure of the article are similar to those explained in the method embodiments above.

The article of the present invention may have a wide variety of applications. In some embodiments, the article is a portion of a rotor or a stator of an electric machine including a generator, a motor, or an alternator. In some embodiments, the article may be a component of a magnetic bearing, an electromagnet pole piece, an actuator, an armature, a solenoid, an ignition core, or a transformer. Embodiments of the present invention encompass any such devices that incorporate magnetic materials produced by the method of the invention.

It should be understood that the present invention should not be construed as to be limited to a stator or a rotor. Instead the invention should be construed to include other magnetic parts having their own respective three-dimensional shapes. It includes all magnetic motor and generator parts, armatures, rotors, solenoids, linear actuators, gears, ignition cores, transformers, ignition coils, converters, inverters and the like.

The method of the present invention is designed to meet fundamentally different design requirements from those applied to conventional methods used for making magnetic materials with ultra-fine grain structure. Typically used methods to make fine grained magnetic materials such as controlled thermal processing after conventional deformation processing or compaction of nanocrystalline powders have not increased strength radically and have been deleterious to the core loss properties. Conventionally used processes to make nanocrystalline magnetic materials such as rapid solidification suffer from a number of drawbacks. Generally rapidly solidified soft magnetic materials have low coercivity and high strength but are limited to thicknesses of less than 20 microns. In addition, rapidly solidified nanocrystalline materials are brittle. The method of the present invention provides magnetic materials with superior magnetic and mechanical properties. It provides magnetic materials that are substantially free of porosity, inhomogeniety, and which are ductile.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method comprising:
providing a soft magnetic starting material; and
deforming the soft magnetic starting material within a dynamic recrystallization processing zone to form a billet having a grain size less than about 200 nm.

2. The method according to claim 1, wherein the soft magnetic starting material comprises at least about 50 weight percent of a material selected from the group consisting of iron, nickel, cobalt, and combinations thereof.

3. The method according to claim 1, wherein the soft magnetic starting material further comprises an additive selected from the group consisting of V, Si, Ti, B, Nb, Cr, Mn, Mo, Al, Ni, Ta, C, and combinations thereof.

4. The method according to claim 3, wherein the additive is present in a total amount of up to about 6 atomic percent.

5. The method according to claim 1, wherein the soft magnetic starting material comprises Fe and Co.

6. The method according to claim 5, wherein the soft magnetic starting material comprises cobalt in the range from about 15 atomic percent to about 55 atomic percent.

7. The method according to claim 6, wherein the soft magnetic starting material comprises cobalt in the range from about 30 atomic percent to about 40 atomic percent.

8. The method according to claim 6, wherein the soft magnetic starting material comprises cobalt in the range from about 45 atomic percent to about 52 atomic percent.

9. The method according to claim 1, wherein the soft magnetic starting material comprises Fe, Co, and V.

10. The method according to claim 9, wherein the soft magnetic starting material comprises Co in an amount of up to about 49 atomic percent and V in an amount of up to about 3 atomic percent.

11. The method according to claim 1, wherein deforming comprises at least one of equal channel angular extrusion, twist extrusion, torsion extrusion, multi-axis forging, continuous shear deformation, and uniaxial forging.

12. The method according to claim 1, wherein the billet has a median grain size of less than about 100 nanometers.

13. The method according to claim 12, the billet has a median grain size in the range of about 10 nanometers to about 60 nanometers.

14. An article comprising a magnetic material, wherein the article is formed by:
providing a soft magnetic starting material; and
deforming the soft magnetic starting material within a dynamic recrystallization processing zone to form a billet having a grain size less than about 200 nm.

15. The article of claim 14, wherein the article is a component of an electric device selected from the group consisting of a generator, a motor, and an alternator.

16. The article of claim 15, wherein the article is an electric generator rotor.

17. The article according to claim 1, wherein the article is a component of a device selected from the group consisting of a magnetic bearing, an electromagnet pole piece, an actuator, an armature, a solenoid, an ignition core, or a transformer.

18. A method comprising:
providing a soft magnetic starting material comprising iron and cobalt; and
deforming the soft magnetic starting material within a dynamic recrystallization processing zone to form a billet having a grain size less than about 200 nm.
